(19) United States
(12) Patent Application Publication
(10) Pub. No.: US 2022/0399610 A1
(43) Pub. Date: Dec. 15, 2022

(54) PRESSURE COMPENSATION DEVICE FOR A COMPONENT WITH A SEALED INTERIOR, IN PARTICULAR FOR A BATTERY HOUSING, AND BATTERY HOUSING WITH SUCH PRESSURE COMPENSATION DEVICE

(71) Applicant: Faurecia Emissions Control Technologies, Germany GmbH, Augsburg (DE)

(72) Inventor: Robert BUESCHGES, Augsburg (DE)

(21) Appl. No.: 17/839,576

(22) Filed: Jun. 14, 2022

(30) Foreign Application Priority Data
Jun. 14, 2021 (DE) 10 2021 115 321.2

(51) Int. Cl. H01M 50/342

(52) U.S. Cl. CPC H01M 50/3425

(57) ABSTRACT

A pressure compensation device for a component having a sealed interior, in particular for a battery housing, having a housing, a movable element arranged therein and adapted to be exposed on one side to a pressure prevailing in the interior and on the opposite side to an external pressure outside the component, wherein the movable element is displaceable over a distance specified by design, in order to prevent an overpressure from building up inside the interior, wherein the movable element includes a predetermined breaking point which exposes an outflow opening when a predefined pressure difference between the pressure in the interior and the external pressure is exceeded. A battery housing having a relief opening and such a pressure compensation device.

### FIELD OF THE INVENTION

The invention relates to a pressure compensation device for a component having a sealed interior, in particular for a battery housing. The invention further relates to a battery housing having a relief opening and such a pressure compensation device.

### BACKGROUND OF THE INVENTION

Battery housings as are used in particular for battery-powered motor vehicles, should be hermetically sealed as well as watertight to prevent any substances (gases and chemicals) from being released into the environment or entering the battery during operation. The problem that arises from tightness is that changes in the internal pressure in the battery housing occur, in particular when there are changes in temperature.

When the pressure inside the battery housing rises, this leads to mechanical stresses on structural components of the battery housing. The mechanical stresses are relevant to the fatigue strength of the structural components over the service life of the battery and, in the event of particularly high pressures, may lead to uncontrolled failure of the structural components. In such a case, there is a risk of substances from the interior of the battery housing escaping into the environment in an uncontrolled manner.

### SUMMARY OF THE INVENTION

It is the object of the invention to prevent, by simple design measures, the pressure in the interior of a battery housing from rising heavily. Furthermore, the object of the invention is to prevent an uncontrolled failure of the battery housing when inadmissibly high pressures occur.

The object is achieved by a pressure compensation device including a housing, a movable element arranged therein and adapted to be exposed on one side to a pressure prevailing in the interior and on the opposite side to an external pressure outside the component, wherein the movable element is displaceable over a distance specified by design, in order to prevent an overpressure from building up inside the interior, wherein the movable element includes a predetermined breaking point which exposes an outflow opening when a predefined pressure difference between the pressure in the interior and the external pressure is exceeded. The pressure compensation device according to the invention addresses two problems at the same time: Firstly, a compensation volume is created by means of the movable element so that in the case of temperature changes inside the battery housing, the gas enclosed there can expand without the internal pressure rising heavily. The compensation volume and thus the interior of the battery housing are separated from the exterior by the movable element, so that the interior continues to be hermetically sealed from the exterior. Secondly, the predetermined breaking point ensures that in the case of an excessively high internal pressure, a “pressure outlet opening” is produced, namely at an excess pressure specified by design and at a location specified by design, that is, in the movable element. The pressure compensation device here is arranged such that the gas flowing out through the pressure outlet opening cannot endanger any vehicle occupants, nor any other persons. In particular, the pressure outlet opening is directed towards the floor of the vehicle. The fact that the predetermined breaking point is arranged on the movable element results in a very space-saving construction.

In one embodiment of the invention, a compensation volume by which a volume of the interior can be varied is specified by means of the distance specified by design and at least a portion of a surface of the movable element. This allows the pressure compensation device to be adapted to predefined application-specific requirements with little effort, for example a battery housing size or expectable temperature and/or pressure fluctuations. In one exemplary embodiment, a compensation volume of 60 cubic centimeters may be provided.

In one embodiment of the invention, the movable element comprises a rupture disk. Since rupture disks typically are very flat and thin, a compact construction is achieved. Further advantages include low costs, no maintenance required, and long service life, which arise from the use of rupture disks.

In a further variant embodiment of the invention, the movable element comprises a spring-mounted hollow piston. In one exemplary embodiment, the hollow piston may be supported on a spiral spring having a specified spring constant and may comprise a closed face side. This allows various advantages to be achieved. For instance, the closed face side of the hollow piston provides an area that is large enough to be equipped with a predetermined breaking point. At the same time, the spiral spring allows precise adjustment of a desired pressure compensation range, for example by way of the spring constant.

In a further embodiment of the invention, the movable element comprises a rubber diaphragm. An advantage of the rubber diaphragm is that it has the necessary elastic deformability to be able to displace the movable element, while at the same time creating a barrier that prevents an exchange of material between the interior and the exterior.

In a preferred embodiment, the predetermined breaking point annularly encloses a portion of a surface of the movable element. This allows, in the event of an excessively high internal pressure, the portion enclosed by the predetermined breaking point to be completely detached and expose a pressure release opening of sufficient size for pressure compensation.

A further aspect of the invention provides that at least the housing and the movable element of the pressure compensation device are resistant to cooling liquid. This allows the pressure compensation device to be used for pressure compensation of coolant-filled interiors, such as, for example, traction batteries through which coolant flows.

The object is further achieved according to the invention by a battery housing having a relief opening and a pressure compensation device, wherein the housing of the pressure compensation device is associated with the relief opening so that the movable element seals the relief opening. The advantages discussed above with respect to the pressure compensation device also apply, of course, to the battery housing.

In a preferred embodiment, a surface of the movable element enclosed by an encircling predetermined breaking point is smaller than a cross-section of the relief opening. In an event of damage, this allows parts that have become detached due to breakage of the predetermined breaking point to reach the outside area. In this way, it is ensured that the cleared outflow opening is not blocked by the detached parts and has a flow cross-section that is sufficiently large for pressure compensation.

In addition, it may be provided that the design-specified distance of the movable element is limited by a stop on an inner surface of the battery housing. As a result, the compensation volume is limited by design, ensuring a precise compensation characteristic that causes the predetermined breaking point to respond in the event of a high pressure rise.

### BRIEF DESCRIPTION OF THE DRAWINGS

Further features and advantages of the invention will be apparent from the description below and from the accompanying drawings, to which reference is made and in which:

FIG. 1 shows a schematic representation of a battery housing with a pressure compensation device;

FIG. 2 shows a cross-sectional view of a first embodiment of a pressure compensation device in a first state;

FIG. 3 shows the pressure compensation device of FIG. 2 in a second state;

FIG. 4 shows the pressure compensation device of FIG. 2 in a third state;

FIG. 5 shows a cross-sectional view of a second embodiment of a pressure compensation device in a first state;

FIG. 6 shows the pressure compensation device of FIG. 5 in a second state; and

FIG. 7 shows the pressure compensation device of FIG. 5 in a third state.

### DETAILED DESCRIPTION OF THE INVENTION

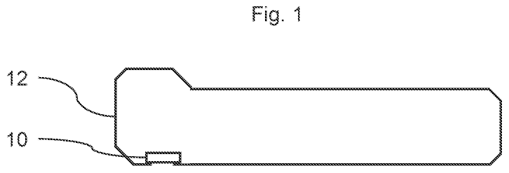

FIG. 1 schematically shows a battery housing 12 that is used to accommodate batteries or accumulators that are intended to supply electrical energy to a motor vehicle.

The battery housing 12 normally is hermetically sealed from the outside environment so that no substances, such as gases and/or chemicals, are released from the battery to the environment and/or enter the battery from the environment during operation.

In order to reduce mechanical stresses on the battery components, in particular on structural components of the battery housing, a pressure compensation device 10, illustrated schematically here, is attached to the battery housing 12, which serves to reduce overpressures in the battery housing 12 and to expose an outflow opening 64 in the event of an excessively high internal pressure.

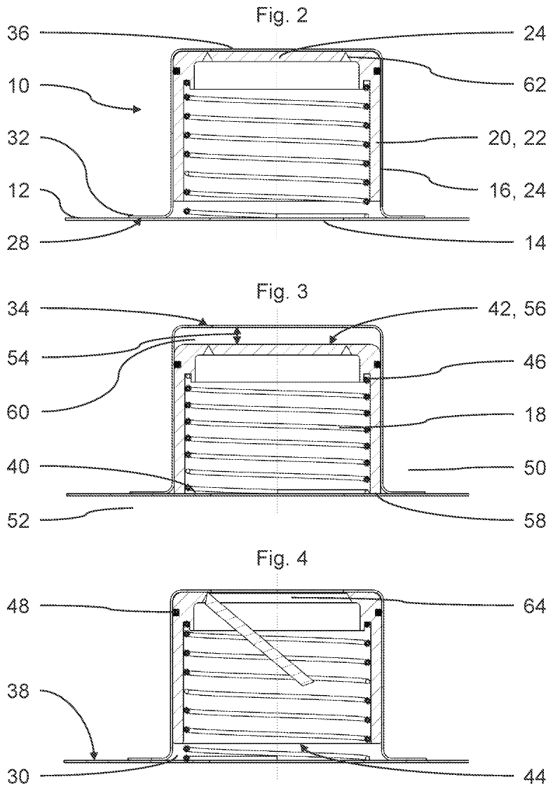

FIGS. 2 to 4 show a first embodiment of the pressure compensation device 10 in detail, which, in the exemplary embodiment, is mounted within the battery housing 12 and is associated with a relief opening 14 in the battery housing 12. In the exemplary embodiment, the relief opening 14 and the pressure compensation device 10 are oriented toward a ground beneath the vehicle.

The pressure compensation device 10 comprises a housing 16, a spiral spring 18, and a movable element 22 that is connected to the spiral spring 18, is formed as a hollow piston 20 and has a rupture disk 24.

The housing 16 of the pressure compensation device 10 is in the form of a deep-drawn cylindrical sheet metal cup 26. Alternatively, the housing 16 of the pressure compensation device 10 may be made from a plastic material, in particular in a cup shape. On a first face side 28, the sheet metal cup 26 comprises a first circular opening 30 and a flange 32 extending around the first opening 30. On a second face side 34, the cylindrical sheet metal cup 26 comprises a second circular opening 36.

In the exemplary embodiment, the housing 16 of the pressure compensation device 10 is fastened in a gas-tight manner to an inner surface 38 of the battery housing 12 by means of the flange 32. In the exemplary embodiment, the fastening is implemented by means of a welded joint. In further embodiments not shown, the housing 16 of the pressure compensation device 10 may also be fastened to the battery housing 12 by soldered, glued, riveted and/or screwed connections and also by other suitable types of connection.

In the embodiment shown, the flange 32 concentrically encloses the relief opening 14 of the battery housing 12 such that the centers of the first and second openings 30, 36 of the housing 16 of the pressure compensation device 10 and the relief opening 14 of the battery housing 12 are on a straight line.

In the exemplary embodiment, the first circular opening 30 of the housing 16 of the pressure compensation device 10 has a larger diameter than the relief opening 14 in the battery housing 12. This produces a shoulder 40 between the flange 32 and the relief opening 14.

In the embodiment described, the spiral spring 18 is supported on the shoulder 40, as shown in FIGS. 2 to 4. The hollow piston 20 is closed at a first face side 42 and open at a second face side 44. The spiral spring 18 protrudes through the open face side 44 and into the hollow piston 20 and is supported on the inner surface thereof in a spring seat 46. The hollow piston 20 is movable in the housing 16 of the pressure compensation device 10 and is acted upon with a force by the spiral spring 18 such that it assumes a particular position in the housing 16 of the pressure compensation device 10.

When the hollow piston 20 moves, its lateral surface is guided by an inner surface of the housing 16 of the pressure compensation device 10, so that tilting of the hollow piston 20 is prevented.

A sealing ring 48 is disposed in a groove of the hollow piston 20. The interior 50 of the battery housing 12 is sealed from an outside area 52 by direct contact of the sealing ring 48 with the inner surface of the housing 16 of the pressure compensation device 10, thereby preventing substances, such as gases or chemicals, from being exchanged between the interior 50 and the outside area 52 during operation.

The relief opening 14 in the battery housing 12 and the first opening 30 in the housing 16 of the pressure compensation device 10 cause the open face side 44 of the hollow piston 20 to be exposed to an external pressure that prevails outside the battery housing 12.

At the same time, the closed face side 42 of the hollow piston 20 is exposed to an internal pressure prevailing in the interior 50 of the battery housing 12 by way of the second opening 36 in the housing 16 of the pressure compensation device 10.

In the event that a force acting on the hollow piston 20 due to the internal pressure is smaller than a counterforce which, in the exemplary embodiment, is composed of a spring force and a force acting on the hollow piston 20 due to the external pressure, the spiral spring 18 presses the hollow piston 20 by its closed face side 42 against the inner surface of the housing 16 of the pressure compensation device 10, as shown in FIG. 2. In the exemplary embodiment, the force acting on the hollow piston 20 due to the internal pressure corresponds to the internal pressure multiplied by the face side area 56 of the hollow piston 20. The force acting on the hollow piston 20 due to the external pressure corresponds to the external pressure multiplied by the face side area 56.

In the event that the force acting on the hollow piston 20 due to the internal pressure is greater than the counterforce, the spiral spring 18 is compressed and the hollow piston 20 is displaced in the housing 16 of the pressure compensation device 10, as shown in FIG. 3.

In the embodiment described, a displacement distance 54 of the hollow piston 20 is limited in that its open face side 44 comes to abut against the shoulder 40 on the inside of the battery housing 12 between the flange 32 and the relief opening 14, as shown in FIG. 3.

Free space within the housing 16 of the pressure compensation device 10 resulting from a displacement of the hollow piston 20 serves as a compensation volume 60 for a gas present within the interior 50 of the battery housing 12. This allows the gas to expand in a controlled manner, for example due to a charging-related temperature rise within the battery, without an overpressure occurring inside the battery housing 12. The interior 50 and the outside area 52 remain materially separated from each other here by the hollow piston 20 and the sealing ring 48. In the exemplary embodiment, the compensation volume 60 corresponds to a face side area 56 of the hollow piston 20 multiplied by the displacement distance 54 of the hollow piston 20. In one example, the compensation volume amounts to about 60 cubic centimeters. The limitation of the displacement distance 54 here ensures that this volume value is precisely observed.

In the embodiment described, the closed face side 42 of the hollow piston 20 comprises a predetermined breaking point 62, which extends centrically about the face side center at a predefined distance. In the exemplary embodiment shown, the predetermined breaking point defines the rupture disk 24 already mentioned above.

When a specified pressure difference between the pressure in the interior 50 and the external pressure is exceeded, for example because of battery damage, the predetermined breaking point 62 will break, so that the rupture disk 24 will expose an outflow opening 64, as shown in FIG. 4. Gas under pressure can be released from the interior 50 of the battery housing 12 into the outside area 52 in a controlled manner through the outflow opening 64. This prevents excess pressures from building up in the battery housing 12, which may lead to deformation or even uncontrolled bursting of the battery housing 12. At the same time, it is ensured by the position, specified by design, of the predetermined breaking point 62 on the hollow piston 20 and by the arrangement of the pressure compensation device 10 on the underside of the vehicle that no vehicle occupants or other persons are endangered by gas flowing out of the traction battery in the event of damage.

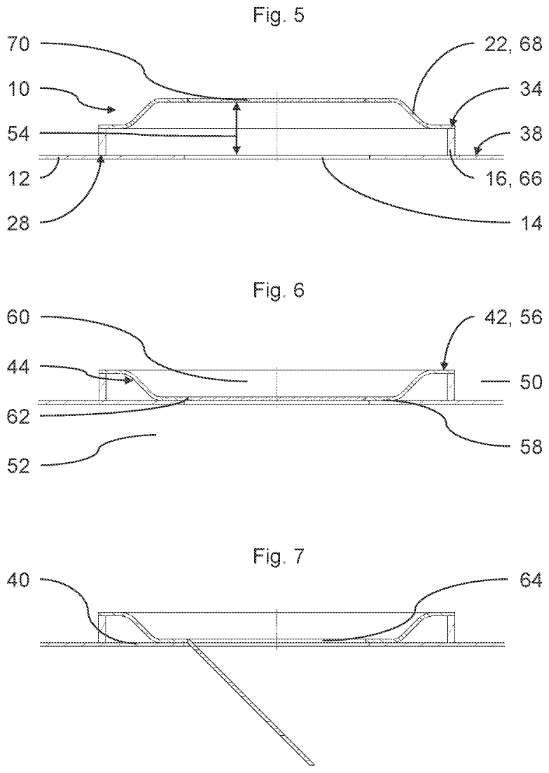

FIGS. 5, 6 and 7 show a second embodiment of a pressure compensation device 10, which is likewise mounted in a battery housing 12 of a traction battery and is associated with a relief opening 14 in the battery housing 12.

The second embodiment corresponds to the first embodiment with regard to several essential features, so that only the differences will be discussed below. Identical and functionally identical parts are provided with the same reference numbers.

In the second embodiment, the housing 16 of the pressure compensation device 10 is formed as a plastic ring 66. A first face side 28 of the plastic ring 66 is arranged concentrically with the relief opening 14 in the battery housing 12 and fixed in place on the inner surface 38 thereof by means of a gas- and liquid-tight adhesive joint.

A movable element 22 is arranged on an opposite, second face side 34 of the plastic ring 66. In the embodiment described, the movable element 22 is a cup-shaped rubber diaphragm 68, in the center of which a circular disk 70 is embedded. In the exemplary embodiment, the disk is also made from plastic.

An edge of the rubber diaphragm 68 is connected to the second face side 34 of the plastic ring 66 in a gas- and liquid-tight manner by means of an adhesive joint, so that the interior 50 of the battery housing 12 is hermetically sealed from the outside area 52 by means of the rubber diaphragm 68.

In the embodiment described, the plastic ring 66, the rubber diaphragm 68, and the disk 70 are made from materials that are resistant to cooling liquid.

An outer shell side of the plastic ring 66 as well as a first side of the rubber diaphragm 68 and of the disk 70 are exposed to a coolant present in the battery housing 12 and to an internal pressure prevailing in the interior 50. The sides of the components 66, 68, 70 respectively opposite to the aforementioned sides are exposed to an atmosphere prevailing outside the battery housing 12 and to an external pressure.

In the event that the internal pressure is smaller than or equal to the external pressure, the cup-shaped rubber diaphragm 68 protrudes beyond the plastic ring 66 and into the interior 50 of the battery housing 12, as shown in FIG. 5.

In the event that the internal pressure is greater than the external pressure, a force acts on the rubber diaphragm 68 and on the disk 70 which, when a predefined minimum value is exceeded, causes the rubber diaphragm 68 to snap over and, as shown in FIG. 6, to protrude into the plastic ring 66. By analogy with the first exemplary embodiment, this creates a free space by the volume 60 of which a medium located in the interior 50 of the battery housing 12 can expand without any material exchange taking place with the outside area 52.

The inner surface 38 of the battery housing 12 serves as a stop 58 for the rubber diaphragm 68 here and specifies a maximum displacement distance 54.

In the embodiment described, a contact surface between the rubber diaphragm 68 and the embedded disk 70 is formed as a predetermined breaking point 62.

When a specified pressure difference between the pressure in the interior 50 and the external pressure is exceeded, the predetermined breaking point 62 will break. As a result, the disk 70 is pressed out of the rubber diaphragm 68 and, as shown in FIG. 7, exposes an outflow opening 64, through which medium under pressure is released from the interior 50 of the battery housing 12 into the outside area 52 in a controlled manner.

In the exemplary embodiment, both the disk 70 and the relief opening 14 are round and arranged concentrically with each other. In this regard, the diameter of the disk 70 is smaller than a diameter of the relief opening 14 so that in the event of damage, the disk 70 can pass through the relief opening 14. This ensures that no detached parts will obstruct the outflow opening 64.

1. A pressure compensation device for a component having a sealed interior, comprising a housing, a movable element arranged therein and adapted to be exposed on one side to a pressure prevailing in the interior and on an opposite side to an external pressure outside the component, wherein the movable element is displaceable over a distance specified by design, in order to prevent an overpressure from building up inside the interior, wherein the movable element includes a predetermined breaking point which exposes an outflow opening when a predefined pressure difference between the pressure in the interior and the external pressure is exceeded.

2. The pressure compensation device according to claim 1, wherein a volume by which a volume of the interior can be varied is specified by means of the distance specified by design and at least a portion of a surface of the movable element.

3. The pressure compensation device according to claim 1, wherein the movable element comprises a rupture disk.

4. The pressure compensation device according to claim 1, wherein the movable element comprises a spring-mounted hollow piston.

5. The pressure compensation device according to claim 1, wherein the movable element comprises a rubber diaphragm.

6. The pressure compensation device according to claim 1, wherein the predetermined breaking point annularly encloses a portion of a surface of the movable element.

7. The pressure compensation device according to claim 1, wherein at least the housing and the movable element are resistant to cooling liquid.

8. A battery housing comprising a relief opening and the pressure compensation device according to claim 1, wherein the housing of the pressure compensation device is associated with the relief opening so that the movable element seals the relief opening.

9. The battery housing according to claim 8, wherein a surface of the movable element enclosed by an encircling predetermined breaking point is smaller than a cross-section of the relief opening.

10. The battery housing according to claim 8, wherein the design-specified distance of the movable element is limited by a stop on an inner surface of the battery housing.

11. The battery housing according to claim 9, wherein the design-specified distance of the movable element is limited by a stop on an inner surface of the battery housing.

12. The pressure compensation device according to claim 1, wherein the component having the sealed interior is a battery housing.
